(19) United States
(12) Patent Application Publication
(10) Pub. No.: US 2006/0098359 A1
(43) Pub. Date: May 11, 2006

(54) Surge-suppression system for submersible electric motors

(76) Inventor: Jack Bevington, Ashland, OH (US)

Correspondence Address: ROETZEL AND ANDRESS, 222 SOUTH MAIN STREET, AKRON, OH, 44308, US

(21) Appl. No.: 10/984,038

(22) Filed: Nov. 9, 2004

(51) Int. Cl. H02H 7/08

(52) U.S. Cl. 361/23

(57) ABSTRACT

A submersible motor having electrical-surge protection. The submersible motor includes a motor housing formed from an electrically-conductive material; a stator-winding assembly disposed within, and electrically insulated from the motor housing; a power wire for transmitting electrical energy delivered by an external power source to the stator-winding assembly within the housing; and an end ring formed from an electrically-conductive material. The submersible motor further includes a surge-protection assembly having a surge protector that includes two opposing electrode surfaces that are held a distance apart by an insulator and a coupling member formed from an electrically-insulating material. The coupling member abuts the power wire against the surge-protection assembly to establish an electrically-conductive path between the power wire and the surge-protection that is substantially devoid of wires.

### FIELD OF THE INVENTION

The invention relates generally to the dissipation of unwanted electrical energy, and more particularly to a surge-suppression assembly and a submersible motor provided with such a surge-suppression assembly for minimizing the complexity of submersible-motor construction and for dissipating surges in electrical energy delivered to submersible motors.

### BACKGROUND OF THE INVENTION

Electric motors are used in the construction and operation of pumps that are placed below ground in a well and which are submerged in water. Such motors, like all motors, require protection from sudden high voltage surges; caused by unpredictable occurrences such as nearby lightning strikes. Typically, because such pumps are installed in wells below ground, servicing such a unit is very difficult and expensive.

It is generally known in the art to provide surge protection systems to such systems that protect against increased voltage encountered by power supply wires leading into the pump motor.

Some well known surge protection systems operate external to the electric motor housing, such as the system disclosed in U.S. Pat. No. 4,538,200. Typically, such external systems are provided above ground. However, because they are remote from the motor, they do not offer protection against surges induced between the surge protection system and the motor.

Alternatively, surge protection systems have been provided within the power line at a location near but still external to the motor. As the distance diminishes between the motor and the surge protection system, protection is generally increased. However, such surge protection systems have problems making their use unattractive in well or other submerged applications. Additionally, such systems are available at great expense, making them unattractive solutions.

It is also known to provide a surge suppression system directly within the motor housing, as disclosed by U.S. Pat. Nos. 4,967,303 and 4,437,027. For example, U.S. Pat. No. 4,437,027 discloses a surge absorber unit molded into the motor housing. However, such construction requires embedded wiring in the motor housing unit in order to electrically connect the surge protector to other components of the motor. Such wiring makes assembly of the motor time consuming and requires more space within the motor housing. Due to the time intensive, manual placement of the surge protector within the motor housing, maintenance and/or repair of the surge protection unit is difficult and expensive.

Accordingly, there is a need in the art for a surge-suppression device and system, and a submersible motor provided with such a surge-suppression device and system. The surge-suppression device and system should allow unexpected surges in electricity to be dissipated without causing significant damage to the submersible motor to which the surge protection is afforded. Further, the surge suppression device and system should minimize the complexity of the submersible-motor assembly.

### SUMMARY OF THE INVENTION

The present invention achieves these and other objectives by providing a submersible motor having electrical-surge protection, the submersible motor comprising a motor housing formed from an electrically-conductive material, a stator-winding assembly disposed within, and electrically insulated from the motor housing, a power wire for transmitting electrical energy delivered by an external power source to the stator-winding assembly within the housing, and an end ring formed from an electrically-conductive material. The motor further comprises a surge-protection assembly that includes a surge protector comprising two opposing electrode surfaces that are held a distance apart by an insulator and a coupling member formed from an electrically-insulating material. The coupling member abuts the power wire against the surge-protection assembly to establish an electrically-conductive path between the power wire and the surge-protection that is substantially devoid of wires.

In accordance with one aspect, the present invention provides a submersible motor having electrical-surge protection, the motor comprising a motor housing formed from an electrically-conductive material; a stator-winding assembly disposed within, and electrically insulated from the motor housing; and an end ring formed from an electrically-conductive material. The motor further comprises a surge-protection assembly including a surge protector having two opposing electrode surfaces that are held a distance apart by an insulator and a coupling member formed from an electrically-insulating material. The coupling member is provided with a first aperture through which a conductive member can extend to provide electrical communication between an external source of electrical energy and the stator-winding assembly, and the coupling member is provided with a second aperture for positioning the surge-protection assembly between the end ring and the power wire.

In accordance with another aspect, the present invention also provides a submersible motor having electrical-surge protection, the motor comprising a motor housing formed from an electrically-conductive material; a stator-winding assembly disposed within, and electrically insulated from the motor housing; and an end ring formed from an electrically-conductive material, the end ring defining an aperture through which a power wire can extend to provide electrical communication between an external source of electrical energy and the stator-winding assembly. An electrically-insulating coupling member is provided to maintain a position the power wire adjacent to the aperture in the end ring. The motor further comprises a surge-protection assembly including a surge protector having two opposing electrode surfaces that are held a distance apart by an insulator, wherein the coupling member supports the surge-protection assembly in a position such that the surge-protection assembly abuts power wire.

In accordance with yet another aspect, the present invention also provides a submersible motor having electrical-surge protection, the motor comprising a motor housing formed from an electrically-conductive material; a stator-winding assembly disposed within, and electrically insulated from the motor housing by a potting compound; an end-ring formed from an electrically-conductive material, the end ring defining an aperture through which a conductive member can extend to provide electrical communication between an external source of electrical energy and the stator-winding assembly; an electrically-insulating coupling member to support the power wire adjacent to the aperture in the end ring; and a surge-protection assembly comprising a longitudinal axis and two opposing electrode surfaces that are held a distance apart along the longitudinal axis by an insulator. A position of the surge-protection assembly is maintained in a fixed position relative to the end ring by the coupling member to establish an electrical-surge discharge path along the longitudinal axis of the electrical-surge protection device between the power wire and the end ring.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a recording system in accordance with an embodiment of the present invention; and

FIG. 2 is an illustrative implementation of a recording system in accordance with the present invention for use in a medical environment.

### DETAILED DESCRIPTION OF ILLUSTRATIVE EMBODIMENTS OF THE INVENTION

Certain terminology is used herein for convenience only and is not to be taken as a limitation on the present invention. Further, in the drawings, certain features may be shown in somewhat schematic form.

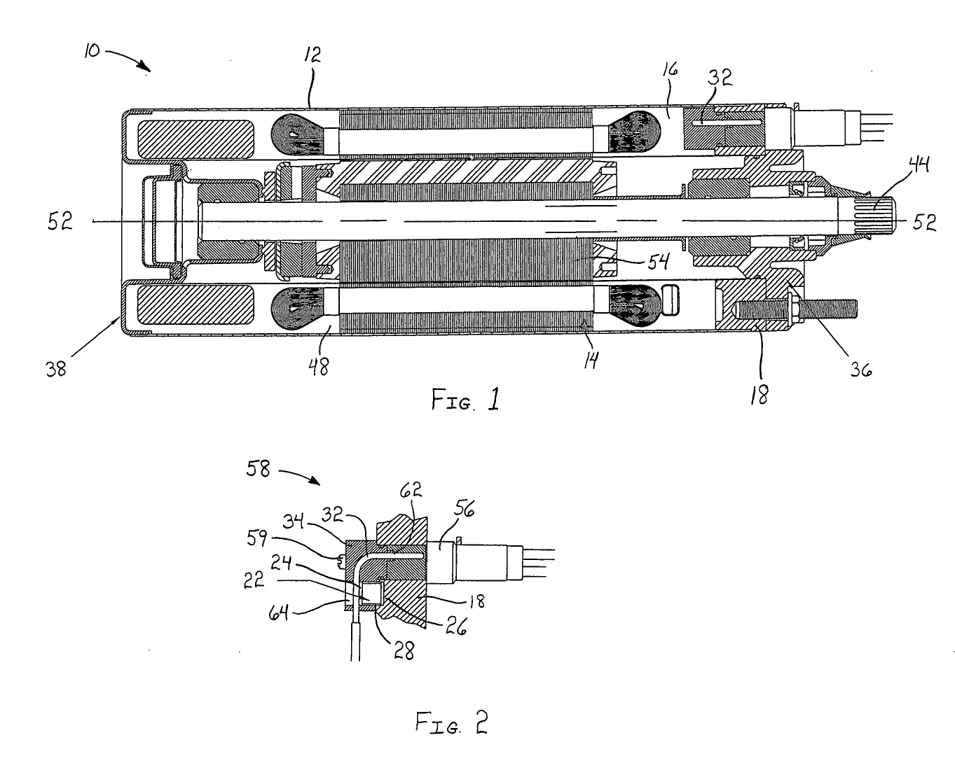

As shown in FIG. 1, a submersible motor 10 having electrical-surge protection according to the present invention comprises a motor housing 12 formed from an electrically-conductive material; a stator-winding assembly 14 disposed within, and electrically insulated from the motor housing 12 by a potting compound 16; and an end ring 18 formed from an electrically-conductive material. An electrical-surge-protection device 22 (FIG. 2), also referred to herein as a surge protector, comprising two opposing electrode surfaces 24, 26 that are held a distance apart by an insulator 28 is provided in electrical communication between a power wire 32 and the end ring 18. An electrically-insulating coupling member 34 is installed in the submersible motor 10 to support the surge protector 22 in the path of electrical conductivity between the power wire 32 and the end ring 18 to allow a potentially-damaging surge of electrical energy to be transmitted to the motor housing 12, from which it can be safely transmitted to electrical ground without significant damage to the submersible motor 10.

Referring again to FIG. 1, the stator-winding assembly 14 is disposed in a coaxial relationship with and is enclosed by the motor housing 12. First and second end walls 36, 38 are connected to opposite ends of the motor housing 12. The upper and lower end walls 36, 38 are disposed in a coaxial relationship with each other and with the housing 12. Generally fluid-tight connections are formed between each of the first and second end walls 36, 38 and the housing 12.

The first end wall 36 has a shape suitable to enclose one end of the housing 12 and includes an aperture 42 through which a drive shaft 44 can extend and another aperture 46 that permits electrical communication between an external power source and the submersible motor 10 for delivering electrical energy to be transmitted to the stator winding assembly 14. The first end wall 36 also includes a seat 46 that is compatible for accepting and maintaining the end ring 18 in a fixed position. Alternate embodiments include an end ring 18 that is formed integrally as part of the first end wall 36.

Although the present invention is described below as including the surge protector 22 coupled to the end ring 18 to transmit a potentially-damaging surge of electrical energy to ground, it should be appreciated that the surge protector 22 can be coupled to any electrically-conductive portion in electrical communication with the motor housing 12, or even the motor housing 12 itself, that is grounded when the submersible motor 10 is installed. When installed in a submersible application, at least one portion of the housing 12 is grounded to dissipate electrical energy transmitted to the housing 12 during operation. This portion of the motor housing 12 to be grounded is referred to herein as a groundable portion of the motor housing 12. This can include the entire motor housing 12, which includes the first and second end walls 36, 38.

Stator windings are disposed within a stator chamber 48 of the motor 10 and form a generally-cylindrical stator-winding assembly 14 that extends along a portion of the longitudinal axis 52 of the motor. A rotor 54 is rotatably supported radially inward of, and coaxial with the stator-winding assembly 14 such that the stator-winding assembly 14 extends around the rotor 54. The drive shaft 44 is coupled to the rotor 54 within the motor housing 12 and extends out of the motor housing 12 to be operatively coupled to a submersible pump (not shown). Rotation of the rotor 54 is transmitted to the drive shaft 44, which in turn rotates an impeller assembly within the pump to which the drive shaft is connected. The pump can be integrally formed as a single unit along with the submersible motor 10, or, the pump can be connected to the submersible motor 10 at the location where the submersible motor 10 is to be installed.

Voids in the stator chamber 48 are filled with a potting compound 16. The potting compound 16 can be any electrically-insulating material such as a plastic, insulating fluid, compressed air, and the like. The potting compound 16 provides support for the tubular housing 12 to minimize deflection or collapse of the motor housing 12 under the pressure imparted thereon by a fluid in which the motor 10 is submerged. An example of a suitable potting compound 16 is an epoxy resin. A suitable epoxy resin that can be used as the potting compound 16 may be selected from many resins in the exercise of sound design judgment, but in all cases will have sufficient 12 rigidity to withstand fluid pressure forces exerted on the external surface of the motor housing 12 in the intended environment of use.

The potting compound 16 fills spaces between the stator-winding assembly 14 and portions of the motor housing 12, thus electrically insulating the stator windings from the motor housing 12, which is to be grounded upon installation. At least some voids between individual stator windings can also be filled with the potting compound 16.

The power wire 32 can be any type of electrically-conducting element that can transmit electrical energy from an external power source to the stator windings. As shown in FIG. 2, the power wire 32 is in the form of a rigid pin that mates with a compatible connection feature, such as a plug 56 belonging to the external power source, to transmit electrical energy from the external power source to the stator-winding assembly 14 of the submersible motor 10. However, the power wire 32 can be any generally-rigid electrically-conducting member that transmits the electrical energy from the external power source to the internal electrical components of the submersible motor 10. For example, the power wire can be a deformable wire that has its shape retained by a neighboring feature such as the coupling member 34 or the potting compound 16.

A surge-protection assembly 58 in accordance with the present invention includes the surge protector 22, and optionally an electrically-conductive spacer (not shown) that can be used to separate the surge protector 22 from a portion of the motor housing 12, the power wire 32, or both. The spacers can be pieces of metal in the form of a disc such as a conventional washer, and the like. The spacers are different than wires used to establish electrical communication between each of the electrodes 24, 26 and the power wire 32 and/or the end ring 18 in that wires are slender, flexible conductors that typically have a length that is greater than their diameter. Installation of wires between the surge protector 22 and adjacent features requires intricate manufacturing steps to secure metal to metal, such as soldiering or welding, that add to the complexity of a manufacturing process and are time consuming and expensive. Spacers, in contrast, can be thought of as solid, generally rigid, electrically-conducting members that are abutted or otherwise positioned between an electrode 24, 26 of the surge protector 22 and another conducting surface such as the end ring 18, the power wire 32, the end wall 36, the housing 12, or any other electrically-conductive feature, and any combination thereof. Spacers also typically have a diameter that is greater than, or comparable to their length.

According to one embodiment, which is shown in FIG. 2, the surge-protection assembly 58 is incorporated within the motor housing 12 by creating a rigidly-fixed electrical connection between each of the power wire 32 and the end ring 18. Such a rigidly-fixed electrical connection can be accomplished by rigidly fastening the coupling member 34 within the motor housing 12 to the end ring 18. The coupling member 34 is held in a fixed position relative to the end ring 18 by a bolt, screw, rivet, adhesive, weld, or other fastener 59 that can fixedly fasten the coupling member 34 to the end ring 18 or other portion of the motor housing 12. Alternately, the coupling member can be held in a fixed position relative to the end ring 18 by the potting compound 16 disposed within the motor housing 12. According to yet another embodiment, the coupling member 34 can be the potting compound 16 itself, formed to maintain the electrical communication between the surge protector 22 and each of the power wire 32 and the end ring 18 or other groundable portion of the motor 10.

When installed within the motor housing 12, the coupling member 34 according to one embodiment has a first surface placed adjacent to a surface of the motor housing 12 and/or end ring 18, and a second surface which, in the embodiment shown in FIG. 1, is adjacent to the potting compound 16. The coupling member 34 includes an aperture 62 for receiving the power wire 32 that extends from a position adjacent to the end ring 18 and into the interior of the motor housing 12, and supports the power wire 32 in a fixed position relative to the end ring 18.

According to the embodiment shown in FIGS. 1 and 2, the coupling member 34 also includes an aperture 64 sized to permit passage of the surge protector 22 in the absence of the power wire 32. The aperture 64 is sized to permit an electrode 24, 26 of the surge protector 22 to extend into the aperture 64 a suitable distance so that electrical communication is established between the electrode 24, 26 of the surge protector 22 and the power wire 32. The coupling member 34 is made from an electrically-insulating material to prevent the formation of an electrical short by the coupling member 34 between the electrodes 24, 26 of the surge protector 22. Similarly, when the coupling member 34 is secured to the motor housing 12 with the fastener 59, the other electrode 26 of the surge protector 22, which is not in electrical communication with the power wire 32, is held in electrical communication with the end ring 18, or other groundable portion of the housing 12. This arrangement of the surge protector 22 permits its installation within the motor housing 12 without requiring wires to extend between at least one of the power wire 32 and end ring 18, and the surge protector 22. Instead, the surge protector 22 simultaneously abuts against the power wire 32 and the end ring 18 when the submersible motor 10 is assembled, thereby forming a wire-free electrical connection between these features.

According to embodiments where one or more spacers are used, at least one spacer extends between the power wire 32 and the surge protector 22, or between the end ring 18 and the surge protector 22, or both. Thus, the electrodes 24, 26 of the surge protector 22 can abut directly against the power wire 32 and the end ring 18, or one or more spacers can be employed to separate the surge protector 22 from one or both of the power wire 32 and the end ring 18 without disrupting the electrical communication there between.

Various embodiments of the present invention include different surge protectors 22 in the surge-protection assembly 58. One embodiment uses a gas discharge tube type surge protector, which has two electrodes 24, 26, one on each opposing end of a gas-filled chamber 66 defined by a dielectric material, or insulator 28, such as glass. Such surge protectors 22 are well known and can be purchased from Products, Inc. However, it is understood that any conventional surge protector 22 that possesses two or more electrodes that can each abut at least one of the power wire 32 and an electrically-conducting portion of the motor housing 12 such as the end ring 18 can be included in the surge-protection assembly 58 of the present invention.

Although described above as a submersible motor 10 having a single power wire 32 and a single surge protector 22, the scope of the present invention includes submersible motors 10 that include a plurality of power wires 32 to transmit electrical energy from an external power source to internal electrical components within the motor housing 12. These alternate embodiments further comprise a plurality of surge protector 22, at least one provided in the conducting path between each power wire 32 and the internal electrical components within the motor housing 12. Specifically, each surge protector 22 is disposed within the electrically-conductive path between the power wire 32 and the stator-winding assembly 14. At least one surge protector 22 of the alternate embodiments forms a surge-dissipation path between the power wire 32 and a portion of the motor housing 12 to be grounded by abutting at least one electrode of each surge protector 22 to each of the end ring 18 of the motor housing 12 and the power wire 32.

From the above description of the invention, those skilled in the art will perceive improvements, changes and modifications. Such improvements, changes and modifications within the skill of the art are intended to be covered by the appended claims.

What is claimed is:

1. A submersible motor having electrical-surge protection comprising:
a motor housing formed from an electrically-conductive material;
a stator-winding assembly disposed within, and electrically insulated from the motor housing;
a power wire for transmitting electrical energy delivered by an external power source to the stator-winding assembly within the housing;
an end ring formed from an electrically-conductive material;
a surge-protection assembly comprising a surge protector that includes two opposing electrode surfaces that are held a distance apart by an insulator; and
a coupling member formed from an electrically-insulating material, wherein the coupling member abuts the power wire against the surge-protection assembly to establish an electrically-conductive path between the power wire and the surge-protection that is substantially devoid of wires.

2. The submersible motor according to claim 1, wherein a potting compound electrically insulates the stator-winding assembly from the motor housing.

3. The submersible motor according to claim 2, wherein the potting compound forms the coupling member.

4. The submersible motor according to claim 1, wherein the power wire is a generally-rigid pin that extends through an aperture in the coupling member in which a surge protector is disposed to abut against the surge protector and maintain the surge protector in a fixed position relative to the end ring.

5. The submersible motor according to claim 1, wherein the power wire is a pin that extends outwardly away from the housing to cooperate with a plug provided at a terminus of the external power source.

6. A submersible motor having electrical-surge protection comprising:
a motor housing formed from an electrically-conductive material;
a stator-winding assembly disposed within, and electrically insulated from the motor housing;
an end ring formed from an electrically-conductive material;
a surge-protection assembly comprising a surge protector having two opposing electrode surfaces that are held a distance apart by an insulator; and
a coupling member formed from an electrically-insulating material, wherein
the coupling member is provided with a first aperture through which a conductive member can extend to provide electrical communication between an external source of electrical energy and the stator-winding assembly, and
the coupling member is provided with a second aperture for positioning the surge-protection assembly between the end ring and the power wire.

7. The submersible motor according to claim 6, wherein the coupling member is formed from a potting compound that insulates the stator-winding assembly from the motor housing.

8. A submersible motor having electrical-surge protection comprising:
a motor housing formed from an electrically-conductive material;
a stator-winding assembly disposed within, and electrically insulated from the motor housing;
an end ring formed from an electrically-conductive material, the end ring defining an aperture through which a power wire can extend to provide electrical communication between an external source of electrical energy and the stator-winding assembly;
an electrically-insulating coupling member to maintain a position the power wire adjacent to the aperture in the end ring; and
a surge-protection assembly comprising a surge protector having two opposing electrode surfaces that are held a distance apart by an insulator, wherein
the coupling member supports the surge-protection assembly in a position such that the surge-protection assembly abuts power wire.

9. The submersible motor according to claim 8, wherein the end ring forms a portion of an end wall that encloses one end of the motor housing.

10. The submersible motor according to claim 9, wherein the end wall comprises an aperture through which a drive shaft can extend to be operatively coupled to a fluid pump.

11. The submersible motor according to claim 9, wherein the surge protector is a gas discharge tube type surge protector.

12. The submersible motor according to claim 9, wherein the surge-protection assembly further comprises one or more electrically-conductive spacers adjacent to at least one electrode surface.

13. A submersible motor having electrical-surge protection comprising:
a motor housing formed from an electrically-conductive material;
a stator-winding assembly disposed within, and electrically insulated from the motor housing by a potting compound;
an end-ring formed from an electrically-conductive material, the end ring defining an aperture through which a conductive member can extend to provide electrical communication between an external source of electrical energy and the stator-winding assembly;
an electrically-insulating coupling member to support the power wire adjacent to the aperture in the end ring; and
a surge-protection assembly comprising a longitudinal axis and two opposing electrode surfaces that are held a distance apart along the longitudinal axis by an insulator, wherein
a position of the surge-protection assembly is maintained in a fixed position relative to the end ring by the coupling member to establish an electrical-surge discharge path along the longitudinal axis of the electrical-surge protection device between the power wire and the end ring.
